(19) United States
(12) Patent Application Publication
(10) Pub. No.: US 2025/0145881 A1
(43) Pub. Date: May 8, 2025

(54) COMPOSITIONS AND METHODS FOR GAS LIFTED WELL DELIQUIFICATION

(71) Applicant: ChampionX LLC, Sugar Land, TX (US)

(72) Inventors: Jenny L. PHAN, Tomball, TX (US); Samuel C. MARSH, Houston, TX (US)

(73) Assignee: ChampionX LLC, Sugar Land, TX (US)

(21) Appl. No.: 18/936,748

(22) Filed: Nov. 4, 2024

Related U.S. Application Data
(60) Provisional application No. 63/597,252, filed on Nov. 8, 2023.

(51) Int. Cl. C09K 8/594; C08G 77/46; C09K 8/584; C09K 8/588; E21B 37/06; E21B 43/16

(52) U.S. Cl. CPC C09K 8/594; C08G 77/46; C09K 8/584; C09K 8/588; E21B 43/168; E21B 37/06

(57) ABSTRACT

The present disclosure generally relates to methods and compositions for treating subterranean formations. The compositions include a surfactant and may optionally include a solvent. The compositions may also include an additional component, such as a biocide, a scale inhibitor, and/or a corrosion inhibitor. The compositions may be used in methods for enhancing gas lift and increasing hydrocarbon production in subterranean formations.

### TECHNICAL FIELD

The present disclosure generally relates to methods and compositions for treating subterranean formations. More specifically, the disclosure provides compositions comprising surfactants and methods of using the compositions to enhance gas lift and increase hydrocarbon production.

### BACKGROUND

The use of chemical additives for various enhanced oil recovery techniques are widely adapted to increase the rate or amount of hydrocarbon compounds recovered from hydrocarbon-bearing subterranean formations. Conventional uses of chemical additives include surfactants or polymers combined with a fluid, such as a water source, for underground injection. Surfactant chemical additives are used to lower interfacial tensions between the fluid and/or connate (subterranean water source) and the hydrocarbon. The additives also increase wettability of the subterranean formation rock to increase yield of hydrocarbon compounds released and/or the rate of their recovery.

An additional class of additives to enhance hydrocarbon recovery includes gas lift flow improvers. These chemical additives are used in oil and gas wells where formation pressure exceeds the well's hydrostatic pressure, and where modification of the pressure difference can impact the ability of a fluid to move up the wellbore to the surface. As formation pressures decline over time, less liquid moves up to the surface and a gas lift flow improver can be utilized to enhance recovery.

### BRIEF SUMMARY

The present disclosure provides methods for enhancing gas lift and increasing hydrocarbon production. In some embodiments, a method of recovering a fluid from a subterranean formation is provided. The method comprises adding a composition to the fluid in the subterranean formation, foaming the fluid in the subterranean formation, and recovering the fluid from the subterranean formation, wherein the composition comprises a compound of Formula I:

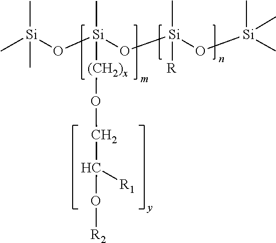

wherein each R is independently selected from a C₁-C₂₀ alkyl, alkenyl, alkynyl, aralkyl, alkoxy, or carbonyl group; wherein each R₁ is independently selected from H or a C₁-C₂₀ alkyl, alkenyl, alkynyl, aralkyl, alkoxy, or carbonyl group; wherein each R₂ is independently selected from H or a C₁-C₂₀ alkyl, alkenyl, alkynyl, aralkyl, alkoxy, or carbonyl group; m is an integer from 1 to about 100; n is an integer from 1 to about 100; x is an integer from 1 to about 50; and y is an integer from 1 to about 50.

The present disclosure also provides compositions for enhancing gas lift and increasing hydrocarbon production. In some embodiments, a composition comprises a foamed fluid, wherein the foamed fluid comprises a hydrocarbon, water, or a combination thereof, and a compound of Formula I.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 shows a chart derived from a foam height test conducted with a composition of the present disclosure and 40% 39 API crude oil;

FIG. 2 shows a chart derived from a foam height test conducted with a prior art composition and 40% 39 API crude oil;

FIG. 3 shows a chart derived from a foam height test conducted with a composition of the present disclosure and 100% 45 API crude oil;

FIG. 4 shows a chart derived from a foam height test conducted with a composition of the present disclosure and 30% 45 API crude oil;

FIG. 5 shows a chart derived from a foam height test conducted with n composition of the present disclosure and 100% 23 API crude oil; and

FIG. 6 shows a chart derived from a foam height test conducted with a composition of the present disclosure and 50% 23 API crude oil.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

As used herein, the term “enhanced hydrocarbon recovery” or “enhanced oil recovery” refers to injection of a composition into a subterranean formation to increase the rate or total amount of hydrocarbon collected from a previously established well. Enhanced hydrocarbon recovery includes “secondary hydrocarbon recovery” which includes injection initiated when a reduction in the rate of flow of hydrocarbon from a well is observed. Enhanced hydrocarbon recovery also includes “tertiary hydrocarbon (oil) recovery,” which includes injection initiated when rate of flow of hydrocarbon from a well has stopped or substantially stopped.

The present disclosure provides methods and compositions for recovering a fluid from a subterranean formation. The compositions may include, for example, a nonionic silicone-based surfactant compound. The compositions may optionally be dispersed in an aqueous medium. In some embodiments, the compositions may be oil-soluble. The compositions may be provided as concentrates, injectates, fracturing fluids, etc.

The inventors discovered that the compositions and methods disclosed herein can effectively foam crude oil in various water cut percentages. Further, the compositions disclosed herein are capable of tolerating produced water containing high total dissolved solids.

The surfactants may increase foaming and/or lower the density of the treated fluids to improve gas lift and therefore hydrocarbon yields, such as crude oil, from subterranean formations. They may also increase the rate of hydrocarbon recovery. In some embodiments, the compositions disclosed herein increase oil production when a gas lift method is being employed in a particular subterranean formation.

A composition of the present disclosure comprises a surfactant compound and optionally a foamed fluid, wherein the foamed fluid comprises a hydrocarbon, water, or a combination thereof. The surfactant compound comprises a compound of Formula I:

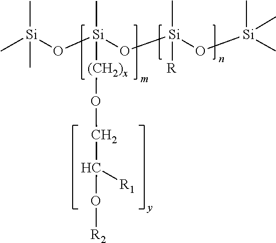

wherein each R is independently selected from a C₁-C₂₀ alkyl, alkenyl, alkynyl, aralkyl, alkoxy, or carbonyl group,
wherein each R₁ is independently selected from H or a C₁-C₂₀ alkyl, alkenyl, alkynyl, aralkyl, alkoxy, or carbonyl group,
wherein each R₂ is independently selected from H or a C₁-C₂₀ alkyl, alkenyl, alkynyl, aralkyl, alkoxy, or carbonyl group,
m is an integer from 1 to about 100,
n is an integer from 1 to about 100,
x is an integer from 1 to about 50, and
y is an integer from 1 to about 50.

As illustrative, non-limiting examples, each R may be independently selected from a C₁-C₁₈ alkyl, alkenyl, alkynyl, aralkyl, alkoxy, or carbonyl group, a C₁-C₁₆ alkyl, alkenyl, alkynyl, aralkyl, alkoxy, or carbonyl group, C₁-C₁₄ alkyl, alkenyl, alkynyl, aralkyl, alkoxy, or carbonyl group, a C₁-C₁₂ alkyl, alkenyl, alkynyl, aralkyl, alkoxy, or carbonyl group, a C₁-C₁ alkyl, alkenyl, alkynyl, aralkyl, alkoxy, or carbonyl group, a C₁-C₈ alkyl, alkenyl, alkynyl, aralkyl, alkoxy, or carbonyl group, a C₁-C₆ alkyl, alkenyl, alkynyl, aralkyl, alkoxy, or carbonyl group, a C₁-C₄ alkyl, alkenyl, alkynyl, aralkyl, alkoxy, or carbonyl group, a C₁-C₂ alkyl, alkenyl, alkynyl, aralkyl, alkoxy, or carbonyl group, a C₁ alkyl, alkenyl, alkynyl, aralkyl, alkoxy, or carbonyl group, a C₂ alkyl, alkenyl, alkynyl, aralkyl, alkoxy, or carbonyl group, a C₃ alkyl, alkenyl, alkynyl, aralkyl, alkoxy, or carbonyl group, a C₄ alkyl, alkenyl, alkynyl, aralkyl, alkoxy, or carbonyl group, a C₅ alkyl, alkenyl, alkynyl, aralkyl, alkoxy, or carbonyl group, a C₆ alkyl, alkenyl, alkynyl, aralkyl, alkoxy, or carbonyl group, a C₇ alkyl, alkenyl, alkynyl, aralkyl, alkoxy, or carbonyl group, a C₈ alkyl, alkenyl, alkynyl, aralkyl, alkoxy, or carbonyl group, a C₉ alkyl, alkenyl, alkynyl, aralkyl, alkoxy, or carbonyl group, or a C₁ alkyl, alkenyl, alkynyl, aralkyl, alkoxy, or carbonyl group.

As illustrative, non-limiting examples, each R₁ may be independently selected from a C₁-C₁₈ alkyl, alkenyl, alkynyl, aralkyl, alkoxy, or carbonyl group, a C₁-C₁₆ alkyl, alkenyl, alkynyl, aralkyl, alkoxy, or carbonyl group, C₁-C₁₄ alkyl, alkenyl, alkynyl, aralkyl, alkoxy, or carbonyl group, a C₁-C₁₂ alkyl, alkenyl, alkynyl, aralkyl, alkoxy, or carbonyl group, a C₁-C₁ alkyl, alkenyl, alkynyl, aralkyl, alkoxy, or carbonyl group, a C₁-C₈ alkyl, alkenyl, alkynyl, aralkyl, alkoxy, or carbonyl group, a C₁-C₆ alkyl, alkenyl, alkynyl, aralkyl, alkoxy, or carbonyl group, a C₁-C₄ alkyl, alkenyl, alkynyl, aralkyl, alkoxy, or carbonyl group, a C₁-C₂ alkyl, alkenyl, alkynyl, aralkyl, alkoxy, or carbonyl group, a C₁ alkyl, alkenyl, alkynyl, aralkyl, alkoxy, or carbonyl group, a C₂ alkyl, alkenyl, alkynyl, aralkyl, alkoxy, or carbonyl group, a C₃ alkyl, alkenyl, alkynyl, aralkyl, alkoxy, or carbonyl group, a C₄ alkyl, alkenyl, alkynyl, aralkyl, alkoxy, or carbonyl group, a C₅ alkyl, alkenyl, alkynyl, aralkyl, alkoxy, or carbonyl group, a C₆ alkyl, alkenyl, alkynyl, aralkyl, alkoxy, or carbonyl group, a C₇ alkyl, alkenyl, alkynyl, aralkyl, alkoxy, or carbonyl group, a C₈ alkyl, alkenyl, alkynyl, aralkyl, alkoxy, or carbonyl group, a C₉ alkyl, alkenyl, alkynyl, aralkyl, alkoxy, or carbonyl group, or a C₁ alkyl, alkenyl, alkynyl, aralkyl, alkoxy, or carbonyl group.

As illustrative, non-limiting examples, each R₂ may be independently selected from a C₁-C₁₈ alkyl, alkenyl, alkynyl, aralkyl, alkoxy, or carbonyl group, a C₁-C₁₆ alkyl, alkenyl, alkynyl, aralkyl, alkoxy, or carbonyl group, C₁-C₁₄ alkyl, alkenyl, alkynyl, aralkyl, alkoxy, or carbonyl group, a C₁-C₁₂ alkyl, alkenyl, alkynyl, aralkyl, alkoxy, or carbonyl group, a C₁-C₁₀ alkyl, alkenyl, alkynyl, aralkyl, alkoxy, or carbonyl group, a C₁-C₈ alkyl, alkenyl, alkynyl, aralkyl, alkoxy, or carbonyl group, a C₁-C₆ alkyl, alkenyl, alkynyl, aralkyl, alkoxy, or carbonyl group, a C₁-C₄ alkyl, alkenyl, alkynyl, aralkyl, alkoxy, or carbonyl group, a C₁-C₂ alkyl, alkenyl, alkynyl, aralkyl, alkoxy, or carbonyl group, a C₁ alkyl, alkenyl, alkynyl, aralkyl, alkoxy, or carbonyl group, a C₂ alkyl, alkenyl, alkynyl, aralkyl, alkoxy, or carbonyl group, a C₃ alkyl, alkenyl, alkynyl, aralkyl, alkoxy, or carbonyl group, a C₄ alkyl, alkenyl, alkynyl, aralkyl, alkoxy, or carbonyl group, a C₅ alkyl, alkenyl, alkynyl, aralkyl, alkoxy, or carbonyl group, a C₆ alkyl, alkenyl, alkynyl, aralkyl, alkoxy, or carbonyl group, a C₇ alkyl, alkenyl, alkynyl, aralkyl, alkoxy, or carbonyl group, a C₈ alkyl, alkenyl, alkynyl, aralkyl, alkoxy, or carbonyl group, a C₉ alkyl, alkenyl, alkynyl, aralkyl, alkoxy, or carbonyl group, or a C₁ alkyl, alkenyl, alkynyl, aralkyl, alkoxy, or carbonyl group.

Further, with respect to the “m” variable, illustrative, non-limiting examples include 1 to about 80, 1 to about 60, 1 to about 40, 1 to about 30, 1 to about 25, 1 to about 20, 1 to about 15, 1 to about 10, 1 to about 9, 1 to about 8, 1 to about 7, 1 to about 6, 1 to about 5, 1 to about 4, 1 to about 3, or 1 to about 2.

With respect to the “n” variable, illustrative, non-limiting examples include 1 to about 80, 1 to about 60, 1 to about 40, 1 to about 30, 1 to about 25, 1 to about 20, 1 to about 15, 1 to about 10, 1 to about 9, 1 to about 8, 1 to about 7, 1 to about 6, 1 to about 5, 1 to about 4, 1 to about 3, or 1 to about 2.

With respect to the “x” variable, illustrative, non-limiting examples include 1 to about 45, 1 to about 40, 1 to about 35, 1 to about 30, 1 to about 25, 1 to about 20, 1 to about 15, 1 to about 10, 1 to about 9, 1 to about 8, 1 to about 7, 1 to about 6, 1 to about 5, 1 to about 4, 1 to about 3, or 1 to about 2.

With respect to the “y” variable, illustrative, non-limiting examples include 1 to about 45, 1 to about 40, 1 to about 35, 1 to about 30, 1 to about 25, 1 to about 20, 1 to about 15, 1 to about 10, 1 to about 9, 1 to about 8, 1 to about 7, 1 to about 6, 1 to about 5, 1 to about 4, 1 to about 3, or 1 to about 2.

The carbonyl group may be any carbonyl-containing group, such as an aldehyde or ketone, comprising from about 1 to about 20 carbon atoms, such as about 1 to about 18, about 1 to about 16, about 1 to about 14, about 1 to about 12, about 1 to about 10, about 1 to about 8, about 1 to about 6, about 1 to about 4, or about 1 to about 2 carbon atoms.

In certain embodiments, the surfactant compound comprises the following structure:

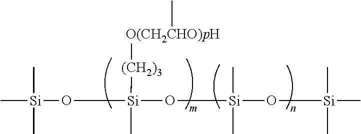

wherein “p” is an integer selected from about 1 to about 50, such as about 1 to about 40, about 1 to about 30, about 1 to about 20, about 1 to about 10, or about 1 to about 5; “m” is an integer selected from about 1 to about 100, such as about 1 to about 90, about 1 to about 80, about 1 to about 70, about 1 to about 60, about 1 to about 50, about 1 to about 40, about 1 to about 30, about 1 to about 20, about 1 to about 10, or about 1 to about 5; and “n” is an integer selected from about 1 to about 100, such as about 1 to about 90, about 1 to about 80, about 1 to about 70, about 1 to about 60, about 1 to about 50, about 1 to about 40, about 1 to about 30, about 1 to about 20, about 1 to about 10, or about 1 to about 5.

In certain embodiments, the surfactant compound comprises a (hydroxypropyleneoxypropyl)methylsiloxane-dimethylsiloxane polymer (CAS No. 68957-00-6).

A composition disclosed herein may include any amount of the surfactant compound. For example, the composition may comprise from about 1 wt. % to about 100 wt. % of the surfactant compound, such as from about 1 wt. % to about 95 wt. %, from about 1 wt. % to about 90 wt. %, from about 1 wt. % to about 85 wt. %, from about 1 wt. % to about 80 wt. %, from about 1 wt. % to about 75 wt. %, from about 1 wt. % to about 70 wt. %, from about 1 wt. % to about 65 wt. %, from about 1 wt. % to about 60 wt. %, from about 1 wt. % to about 55 wt. %, from about 1 wt. % to about 50 wt. %, from about 50 wt. % to about 100 wt. %, from about 60 wt. % to about 100 wt. %, from about 70 wt. % to about 100 wt. %, from about 80 wt. % to about 100 wt. %, or from about 90 wt. % to about 100 wt. % of the surfactant compound.

Any composition disclosed herein may optionally comprise a solvent. A solvent may be selected from, for example, a formate, an alcohol, a glycol, an aliphatic hydrocarbon, an aromatic hydrocarbon, and any combination thereof.

In some embodiments, the solvent is selected from the group consisting of methanol, ethanol, isopropanol, butoxyethanol, ethylene glycol, propylene glycol, methyl ether ethylene glycol, naphtha, kerosene, diesel, toluene, ethylenebenzene, ethylene glycol monobutyl ether, diethylene glycol monobutyl ether, dipropylene glycol butyl ether, xylene, and any combination thereof.

The amount of solvent in the composition is not particularly limited. For example, the composition may comprise from about 1 wt. % to about 99 wt. % of the solvent, such as from about 1 wt. % to about 95 wt. %, from about 1 wt. % to about 90 wt. %, from about 1 wt. % to about 85 wt. %, from about 1 wt. % to about 80 wt. %, from about 1 wt. % to about 75 wt. %, from about 1 wt. % to about 70 wt. %, from about 1 wt. % to about 65 wt. %, from about 1 wt. % to about 60 wt. %, from about 1 wt. % to about 55 wt. %, from about 1 wt. % to about 50 wt. %, from about 50 wt. % to about 99 wt. %, from about 60 wt. % to about 99 wt. %, from about 70 wt. % to about 99 wt. %, from about 80 wt. % to about 99 wt. %, or from about 90 wt. % to about 99 wt. % of the solvent.

Any composition disclosed herein may also comprise an additional component. Illustrative, non-limiting examples of additional components include a corrosion inhibitor, a scale inhibitor, a biocide, a paraffin inhibitor, an emulsifier, a water clarifier, a dispersant, an emulsion breaker, a hydrogen sulfide scavenger, a gas hydrate inhibitor, a pH modifier, a synergistic compound, an asphaltene inhibitor, an antioxidant, a pour point depressant, a viscosity modifier, a flow back aid, a friction reducer, a crosslinking agent, a proppant, an additional nonionic surfactant, a cationic surfactant, an anionic surfactant, an amphoteric surfactant, an oxidizing agent, a water-soluble enzyme, a clay stabilizer, a buffer, and any combination thereof.

The amount of additional component in the composition is not particularly limited. For example, the composition may comprise from about 1 wt. % to about 50 wt. % of the additional component, such as from about 1 wt. % to about 45 wt. %, from about 1 wt. % to about 40 wt. %, from about 1 wt. % to about 35 wt. %, from about 1 wt. % to about 30 wt. %, from about 1 wt. % to about 25 wt. %, from about 1 wt. % to about 20 wt. %, from about 1 wt. % to about 15 wt. %, from about 1 wt. % to about 10 wt. %, from about 1 wt. % to about 5 wt. %, from about 5 wt. % to about 10 wt. %, from about 10 wt. % to about 20 wt. %, or from about 15 wt. % to about 30 wt. % of the additional component.

In certain embodiments, a composition disclosed herein may advantageously comprise a pour point from about −25° C. to about −60° C., such as from about −25° C. to about −50° C., −25° C. to about −40° C., −25° C. to about −30° C., −35° C. to about −60° C., −45° C. to about −60° C., or −55° C. to about −60° C.

The pH of a composition of the present disclosure is not particularly limited. For example, the pH may be from about 1 to about 14, such as from about 2 to about 13, about 3 to about 12, about 4 to about 11, about 5 to about 10, about 6 to about 9, or about 7 to about 8.

A composition of the present disclosure can be formulated based on the intended application. For example, the composition may be formulated as an injectate. An injectate is any aqueous composition that is injected into a subterranean formation to bring about a gas lift, increase in yield or rate of recovery of a hydrocarbon from the subterranean formation. In some embodiments, the composition is a concentrate. In some embodiments, the composition is a fracturing fluid or drilling fluid.

The compositions disclosed herein may optionally be manufactured using produced water and are suitable for injection into a subterranean formation, where the fluids remain stable and do not cause precipitation, separation, or instability, while flowing underground. This, in turn, results in improved recovery of hydrocarbons from the subterranean formation.

The compositions disclosed herein may be used in methods of recovering a fluid from a subterranean formation. For example, a method may comprise adding a composition disclosed herein to the fluid in the subterranean formation, foaming the fluid in the subterranean formation, and recovering the fluid from the subterranean formation. A gas may also be injected into the subterranean formation.

The fluid may comprise a hydrocarbon, water, or a combination thereof. The hydrocarbon may comprise crude oil and/or natural gas. The fluid may optionally comprise from about 100 wt. % to about 10 wt. % of the crude oil, such as from about 100 wt. % to about 20 wt. %, from about 100 wt. % to about 30 wt. %, from about 100 wt. % to about 40 wt. %, from about 100 wt. % to about 50 wt. %, from about 100 wt. % to about 60 wt. %, from about 100 wt. % to about 70 wt. %, from about 100 wt. % to about 80 wt. %, from about 100 wt. % to about 90 wt. %, from about 95 wt. % to about 75 wt. %, or from about 90 wt. % to about 70 wt. % of the crude oil.

The fluid may optionally comprise from about 0 wt. % to about 100 wt. % of water, such as from about 10 wt. % to about 90 wt. %, from about 20 wt. % to about 80 wt. %, from about 30 wt. % to about 70 wt. %, from about 40 wt. % to about 60 wt. %, from about 50 wt. % to about 90 wt. %, from about 50 wt. % to about 75 wt. %, from about 5 wt. % to about 50 wt. %, from about 5 wt. % to about 25 wt. %, or from about 5 wt. % to about 15 wt. % of the water.

The methods disclosed herein may be used to increase the gas lift of hydrocarbon from a subterranean formation (reservoir), increase the rate of hydrocarbon recovery from a subterranean formation, increase the total yield of hydrocarbon recovered from a subterranean formation, or any combination thereof.

The methods may include introducing a composition disclosed herein into a subterranean formation. The composition may be introduced by, for example, injecting the composition into the subterranean formation to be treated. The composition may be introduced into the subterranean formation, for example, with a drilling fluid, a fracturing fluid, or an injectate.

The compositions of the present disclosure may be added continuously or intermittently to the subterranean formation.

The point of addition of the compositions disclosed herein is not particularly limited and the compositions may be added to one or more locations. For example, the compositions may be added to a capstring, an umbilical, a gas lift line, a backside of the subterranean formation, a wellhead, or any combination thereof.

In some embodiments, the composition breaks up deposits present in the subterranean formation, alters the wettability of the subterranean formation to water wet, decreases fluid density within the subterranean formation, and/or increases the relative permeability of the subterranean formation to hydrocarbons. This may lead to an increased flow of hydrocarbons from the subterranean formation. In some embodiments, a composition may be used to lower the relative density of the fluids to improve gas lift flow from the subterranean formation.

In some embodiments, the methods are particularly suitable for a subterranean formation comprising a low permeability formation, such as permeability formation of less than 0.1 mD, or less than 0.01 mD. In some embodiments, the low permeability formation can include wells with loading that occurs when water and condensate enter the bottom of the well.

The methods and compositions described herein can also be used to increase the production of hydrocarbons from a subterranean formation that has already been subject to prior subterranean formation stimulation, such as hydraulic fracturing or matrix stimulation. In some embodiments, the methods and compositions can be used to enhance oil recovery stimulation where compositions are pumped with water into injection well(s) and the oil is recovered from production well(s). In some embodiments, the compositions can be used as additives in stimulation fluids, such as hydraulic fracturing fluids. In some embodiments, the compositions can be injected with other treatment fluids into the formation prior to pumping the stimulation fluids.

The amount of composition and/or compound added to the subterranean formation may be, for example, from about 1 ppm to about 10,000 ppm, such as from about 1 ppm to about 8,000 ppm, about 1 ppm to about 6,000 ppm, about 1 ppm to about 4,000 ppm, about 1 ppm to about 2,000 ppm, about 1 ppm to about 1,000 ppm, about 100 ppm to about 1,000 ppm, about 100 ppm to about 2,000 ppm, about 200 ppm to about 1,000 ppm, about 200 ppm to about 2,000 ppm, or about 200 ppm to about 3,000 ppm.

The composition may remain in the subterranean formation for any period of time in accordance with the methods disclosed herein. In some embodiments, the composition remains within the subterranean formation for about 7 days to about 90 days or more, where it does not separate, precipitate or coagulate.

In some embodiments, the introducing/adding (e.g., injecting) of the composition is carried out after hydraulic fracturing of the subterranean formation. In some embodiments, the composition is injected into a subterranean formation wherein no hydraulic fracturing has been previously carried out. In other embodiments, injecting of the composition is carried out contemporaneously with hydraulic fracturing of the subterranean formation.

The methods and compositions are useful in, for example, secondary and tertiary oil recovery, collectively referred to herein as enhanced oil recovery, which is any injection carried out after the fluid connection of a well is already established. In some embodiments, the composition and methods are particularly useful in obtaining hydrocarbon from tight subterranean rock formations in need of lowering the fluid density to improve gas lift flow or increase production in the subterranean formation.

The methods of enhancing hydrocarbon recovery disclosed herein may alter the hydrocarbon fluid density in the subterranean formation.

Additionally, the methods disclosed herein may be combined with high gas flaw rates to further enhance oil recovery. However, the use of the compositions described herein advantageously may not require any additional or high-efficiency pumps.

The methods and compositions disclosed herein may be used to enhance hydrocarbon recovery from subterranean formations that have previously been depleted.

The compositions and methods disclosed herein are effective in enhancing hydrocarbon recovery from subterranean formations having a fluid with total dissolved solids of about 100 mg/L to about 1,000,000 mg/L, such as from about 1,000 mg/L to about 1,000,000 mg/L, about 10,000 mg/L to about 1,000,000 mg/L, about 50,000 mg/L to about 1,000,000 mg/L, about 100,000 mg/L to about 1,000,000 mg/L, about 250,000 mg/L to about 1,000,000 mg/L, about 500,000 mg/L to about 1,000,000 mg/L, or about 750,000 mg/L to about 1,000,000 mg/L.

The compositions and methods disclosed herein are effective in enhancing hydrocarbon recovery from subterranean formations having crude oil comprising an API of about 20 to about 60, such as from about 20 to about 50, about 20 to about 40, about 20 to about 30, about 30 to about 60, about 40 to about 60, about 50 to about 60, or about 30 to about 50.

The foregoing may be better understood by reference to the following examples, which are intended for illustrative purposes and are not intended to limit the scope of the disclosure or its application in any way.

### Examples

High foam height in lab testing typically translates to increased oil production in the field when compositions and/or methods of the present disclosure are used. As shown in the examples disclosed herein, the compositions of the present disclosure were able to provide superior foam height performance across a range of different oil and water ratios, which indicates broad applicability in the field. The testing carried out by the inventors also showed that the compositions did not cause any phase separation issues nor did they have a negative impact on the water quality.

In the foam height tests, a composition comprising the surfactant was dosed into a bottle containing the test fluid, which was prepared with crude oil, water, or a mixture thereof. The bottle was then gently hand-shaken about 10 times and the mixture was transferred into a graduated 1000 mL column for foam height testing. Nitrogen was sparged into the column at about 1 L/minute to generate foam. The foam height volume in mL was recorded every 15 seconds for 5 minutes. Foam stability or foam half-life was recorded immediately once the sparging gas was stopped.

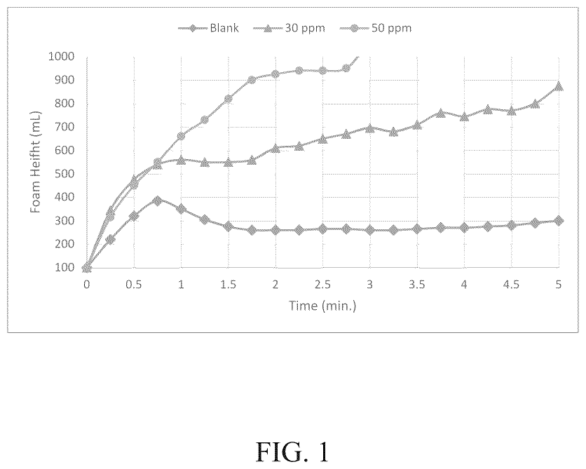

In a first test, the aqueous fluid contained about 40 wt. % of 39 API crude oil and had greater than about 300,000 mg/L total dissolved solids. A (hydroxypropyleneoxypropyl)methylsiloxane-dimethylsiloxane polymer (CAS No. 68957-00-6) was added to the fluid. As can be seen in FIG. 1, after about 2 minutes, the foam height in the blank sample (no surfactant) was about 300 mL while the foam height in the samples treated with about 30 ppm and about 50 ppm of the surfactant was substantially higher.

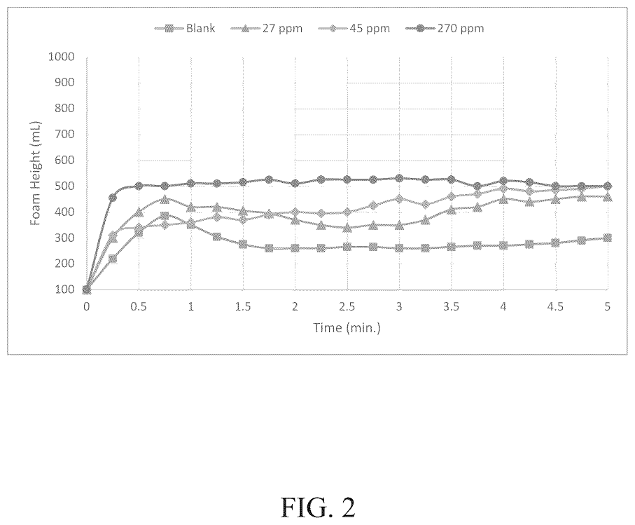

In a second test, the aqueous fluid contained about 40 wt. % of 39 API crude oil and had greater than about 300,000 mg/L total dissolved solids. As can be seen in FIG. 2, the samples treated with the prior art surfactant, which was an alkyl betaine surfactant, never achieved a foam height greater than about 500 mL, which is substantially below the foam height achieved when conducting the test with a fluid treated with a composition of the present disclosure (see FIG. 1).

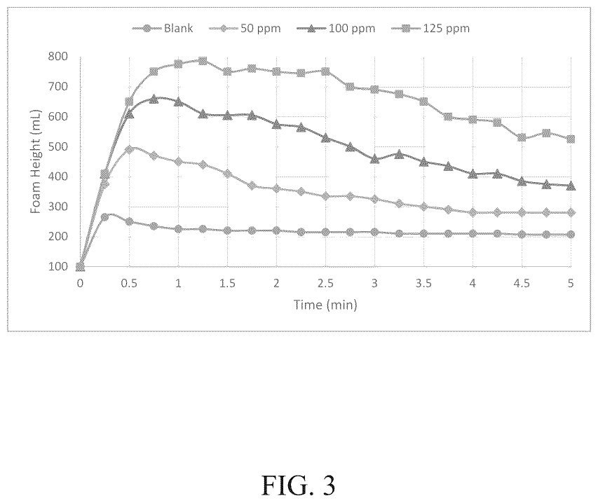

In a third test, the fluid contained about 100 wt. % of 45 API crude oil. A (hydroxypropyleneoxypropyl)methylsiloxane-dimethylsiloxane polymer (CAS No. 68957-00-6) was added to the fluid. As can be seen in FIG. 3, the fluids treated with a composition of the present disclosure (50 ppm, 100 ppm, 125 ppm) achieved substantially higher foam heights as compared to untreated fluid.

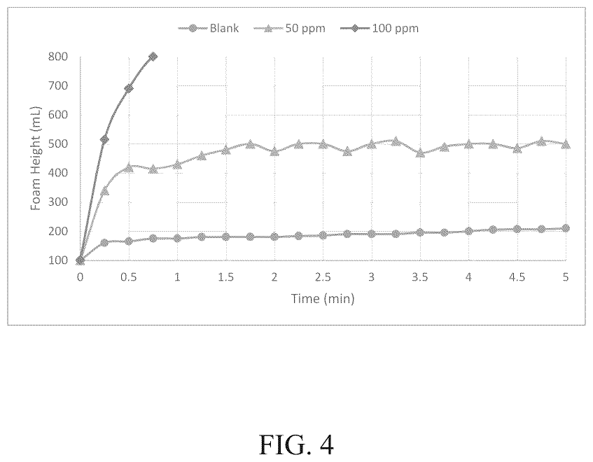

In a fourth test, the aqueous fluid contained about 30 wt. % of 45 API crude oil. A (hydroxypropyleneoxypropyl)methylsiloxane-dimethylsiloxane polymer (CAS No. 68957-00-6) was added to the aqueous fluid. As can be seen in FIG. 4, the fluids treated with a composition of the present disclosure (50 ppm, 100 ppm) achieved substantially higher foam heights as compared to untreated fluid.

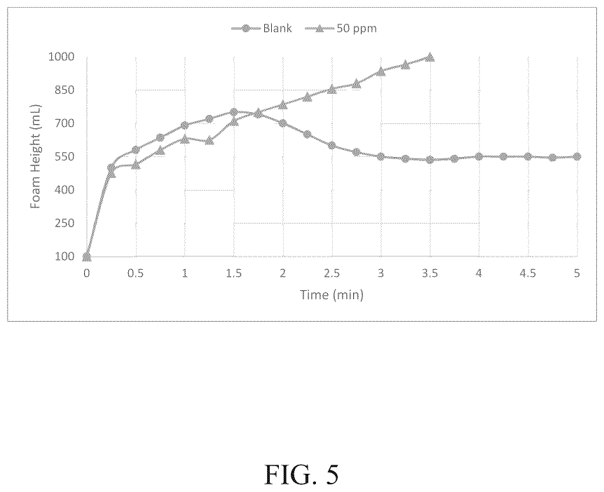

In a fifth test, the fluid contained about 100 wt. % of 23 API crude oil. A (hydroxypropyleneoxypropyl)methylsiloxane-dimethylsiloxane polymer (CAS No. 68957-00-6) was added to the fluid. As can be seen in FIG. 5, after about 2 minutes, the fluid treated with a composition of the present disclosure (50 ppm) achieved substantially higher foam heights as compared to the untreated fluid.

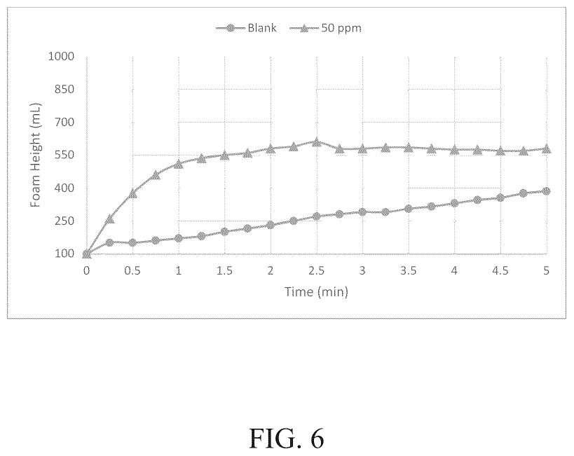

In a sixth test, the aqueous fluid contained about 50 wt. % of 23 API crude oil. A (hydroxypropyleneoxypropyl)methylsiloxane-dimethylsiloxane polymer (CAS No. 68957-00-6) was added to the aqueous fluid. As can be seen in FIG. 6, the fluid treated with a composition of the present disclosure (50 ppm) achieved substantially higher foam heights as compared to the untreated fluid.

Additional bottle tests also showed that fluids of the present disclosure with various ratios of crude oil to water had no phase separation issues when treated with compositions of the present disclosure. All of the water broke out within about 5 minutes of testing and the water quality was comparable to the untreated fluids. Actually, the compositions of the present disclosure displayed an emulsion breaker property as the water broke out at a much faster rate as compared to the water in the untreated sample.

The examples showed that the compositions and methods of the present disclosure achieve a higher initial foam height than the prior art, a higher foam height than the prior art for the full duration of the standard foam height test, and a foam that is more stable.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a surfactant compound” is intended to include “at least one surfactant compound” or “one or more surfactant compounds.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of recovering a fluid from a subterranean formation, comprising:
adding a composition to the fluid in the subterranean formation,
foaming the fluid in the subterranean formation, and
recovering the fluid from the subterranean formation, wherein the composition comprises a compound of Formula I: 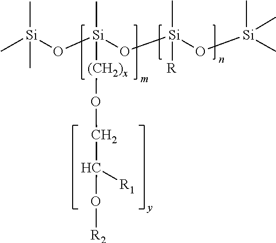
wherein each R is independently selected from a C₁-C₂₀ alkyl, alkenyl, alkynyl, aralkyl, alkoxy, or carbonyl group,
wherein each R₁ is independently selected from H or a C₁-C₂₀ alkyl, alkenyl, alkynyl, aralkyl, alkoxy, or carbonyl group,
wherein each R₂ is independently selected from H or a C₁-C₂₀ alkyl, alkenyl, alkynyl, aralkyl, alkoxy, or carbonyl group,
m is an integer from 1 to about 100,
n is an integer from 1 to about 100,
x is an integer from 1 to about 50, and
y is an integer from 1 to about 50.

2. The method of claim 1, further comprising injecting a gas into the subterranean formation.

3. The method of claim 1, wherein the fluid comprises a hydrocarbon, water, or a combination thereof.

4. The method of claim 3, wherein the hydrocarbon comprises crude oil and/or natural gas.

5. The method of claim 4, wherein the fluid comprises from about 100 wt. % to about 10 wt. % of the crude oil.

6. The method of claim 4, wherein the crude oil comprises an API of about 20 to about 60.

7. The method of claim 3, wherein the water comprises from about 100 mg/L total dissolved solids to about 1,000,000 mg/L total dissolved solids.

8. The method of claim 1, wherein the composition is oil-soluble.

9. The method of claim 1, wherein the composition comprises a solvent.

10. The method of claim 9, wherein the solvent is selected from the group consisting of a formate, an alcohol, a glycol, an aliphatic hydrocarbon, an aromatic hydrocarbon, and any combination thereof.

11. The method of claim 9, wherein the solvent is selected from the group consisting of methanol, ethanol, isopropanol, butoxyethanol, ethylene glycol, propylene glycol, methyl ether ethylene glycol, naphtha, kerosene, diesel, toluene, ethylenebenzene, ethylene glycol monobutyl ether, diethylene glycol monobutyl ether, dipropylene glycol butyl ether, xylene, and any combination thereof.

12. The method of claim 9, wherein the composition comprises from about 1 wt. % to about 99 wt. % of the solvent.

13. The method of claim 1, wherein the composition comprises an additional component selected from the group consisting of a corrosion inhibitor, a scale inhibitor, a biocide, a paraffin inhibitor, an emulsifier, a water clarifier, a dispersant, an emulsion breaker, a hydrogen sulfide scavenger, a gas hydrate inhibitor, a pH modifier, a synergistic compound, an asphaltene inhibitor, an antioxidant, a pour point depressant, a viscosity modifier, a flow back aid, a friction reducer, a crosslinking agent, a proppant, and any combination thereof.

14. The method of claim 13, wherein the composition comprises from about 1 wt. % to about 50 wt. % of the additional component.

15. The method of claim 1, wherein the composition comprises from about 1 wt. % to about 100 wt. % of the compound.

16. The method of claim 1, wherein the composition comprises a pour point from about −25° C. to about −60° C.

17. The method of claim 1, further comprising continuously or intermittently adding the composition to the fluid.

18. The method of claim 1, wherein the composition is added to a capstring, an umbilical, a gas lift line, a backside of the subterranean formation, a wellhead, or any combination thereof.

19. The method of claim 1, wherein the compound is added in an amount ranging from about 1 ppm to about 10,000 ppm.

20. A composition, comprising:
a foamed fluid, wherein the foamed fluid comprises a hydrocarbon, water, or a combination thereof, and
a compound of Formula I: 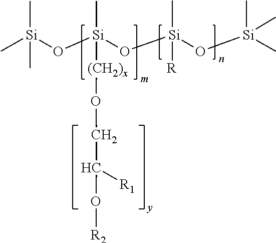
wherein each R is independently selected from a C₁-C₂₀ alkyl, alkenyl, alkynyl, aralkyl, alkoxy, or carbonyl group,
wherein each R₁ is independently selected from H or a C₁-C₂₀ alkyl, alkenyl, alkynyl, aralkyl, alkoxy, or carbonyl group,
wherein each R₂ is independently selected from H or a C₁-C₂₀ alkyl, alkenyl, alkynyl, aralkyl, alkoxy, or carbonyl group,
m is an integer from 1 to about 100,
n is an integer from 1 to about 100,
x is an integer from 1 to about 50, and
y is an integer from 1 to about 50.
